(19) United States
(12) Patent Application Publication
(10) Pub. No.: US 2012/0137244 A1
(43) Pub. Date: May 31, 2012

(54) TOUCH DEVICE INPUT DEVICE AND OPERATION METHOD OF THE SAME

(75) Inventors: Szu-Yu CHU, TAIPEI CITY (TW); Zheng-Jun LU, TAIPEI CITY (TW)

(73) Assignee: INVENTEC CORPORATION, TAIPEI CITY (TW)

(21) Appl. No.: 13/070,484

(22) Filed: Mar. 24, 2011

(30) Foreign Application Priority Data
Nov. 30, 2010 (CN) 201010575386.0

(51) Int. Cl. G06F 3/048; G06F 3/041

(52) U.S. Cl. 715/773

(57) ABSTRACT

A touch device operation method is provided. The touch device input method comprises the steps as follows. A display frame is provided on the touch display module of the touch device, wherein the display frame comprises a software keyboard having virtual keys. A touch input on the touch display module is detected. The touch input is determined to correspond to a triggered key of one of the virtual keys. An amount of characters that the triggered key has is determined. When the amount of characters is not larger than one, the character is displayed on the display frame. When the amount of characters is larger than one, the virtual keys are updated to output under-selection characters in a neighboring area of the triggered key. A displacement of the touch input is detected to select one of the virtual keys. A touch device is disclosed herein as well.

### RELATED APPLICATIONS

This application claims priority to China Application Serial Number 201010575386.0, filed Nov. 30, 2010, which is herein incorporated by reference.

### BACKGROUND

1. Technical Field

The present disclosure relates to an electronic device. More particularly, the present disclosure relates to a touch device and an operation method of the same.

2. Description of Related Art

More and more electronic devices make use of touch panel to replace the traditional display panel and the physical keyboard at the same time such that the electronic device can display the information and allow the user to input command through the touch panel. The software input panel (SIP) is one of the techniques that allow the user to directly input text or sign information to the electronic device through the touch panel.

The main difference between a software keyboard and a physical keyboard is that the user can sense the physical feedback on his/her fingertips when the user touches the physical keyboard and can check whether the texts inputted is correct by viewing the screen at the same time. However, the software keyboard is not able to provide such a kind of physical feedback. Further, when the user presses the software keyboard, the screen is often blocked by the fingers such that the user can not check whether the texts inputted is correct or not. Hence, a visual feedback to intimate the user is necessary.

Accordingly, what is needed is a touch device operation method adapted in a touch device that has an efficient visual feedback mechanism to addresses the above issues.

### SUMMARY

A touch device operation method adapted in a touch device is provided. The touch device operation method comprises the steps as follows. A display frame is provided on a touch display module of the touch device, wherein the display frame displays a software keyboard having a plurality of virtual keys. A touch input is detected on the touch display module. The touch input is corresponding to a triggered key of one of the virtual keys is determined. An amount of characters that the triggered key has is determined such that when the amount of characters is not larger than one, a character corresponding to the triggered key is displayed on the display frame. The virtual keys are updated to output a plurality under-selection characters in a neighboring area of the triggered key when the amount of characters is larger than one. A displacement of the touch input is detected to select one of the virtual keys having the under-selection characters.

Another aspect is to provide a touch device having a dynamic visual feedback mechanism, wherein the touch device comprises a touch display module, a detecting module, a determining module and a processing module. The touch display module provides a display frame to display a software keyboard having a plurality of virtual keys. The detecting module detects a touch input on the touch display module. The determining module determines that the touch input is corresponding to a triggered key of one of the virtual keys and the amount of characters that the triggered key has. The processing module controls the touch display module such that when the amount of characters is not larger than one, the character is displayed on the display frame and when the amount of characters is larger than one, the virtual keys are updated to output a plurality under-selection characters in a neighboring area of the triggered key. The detecting module further detects a displacement of the touch input to select one of the virtual keys having the under-selection characters.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a block diagram of a touch device in an embodiment of the present disclosure;

FIG. 2 is a flow chart of the touch device operation method in an embodiment of the present disclosure;

FIGS. 3A-3C are top views of the touch device in different steps of the flow depicted in FIG. 2;

FIG. 4A and FIG. 4B are top views of the touch device in different steps of the flow depicted in FIG. 2 in another embodiment of the present disclosure;

FIG. 5 is a flow chart of the touch device operation method in another embodiment of the present disclosure;

FIGS. 6A-6F are top views of the touch device in different steps of the flow depicted in FIG. 5;

FIG. 7 is a flow chart of the touch device operation method in yet another embodiment of the present disclosure; and

FIGS. 8A-8E are top views of the touch device in different steps of the flow depicted in FIG. 7.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

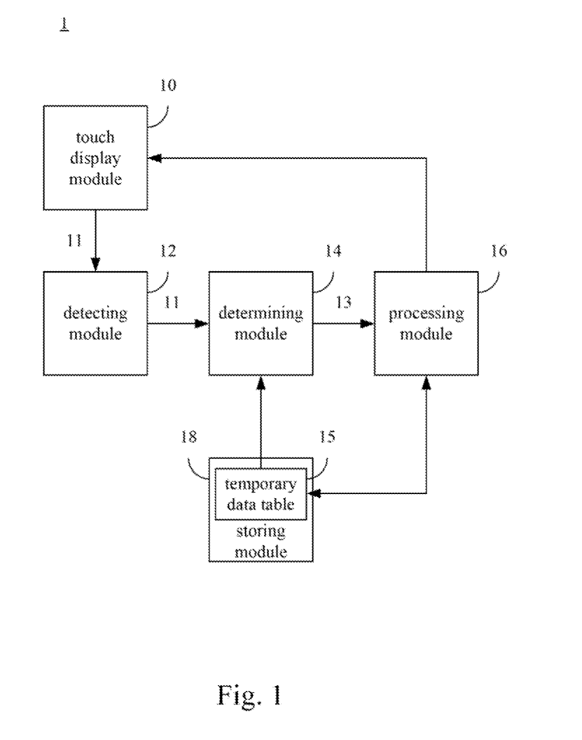

Please refer to FIG. 1. FIG. 1 is a block diagram of a touch device 1 in an embodiment of the present disclosure. The touch device 1 comprises a touch display module 10, a detecting module 12, a determining module 14 and a processing module 16.

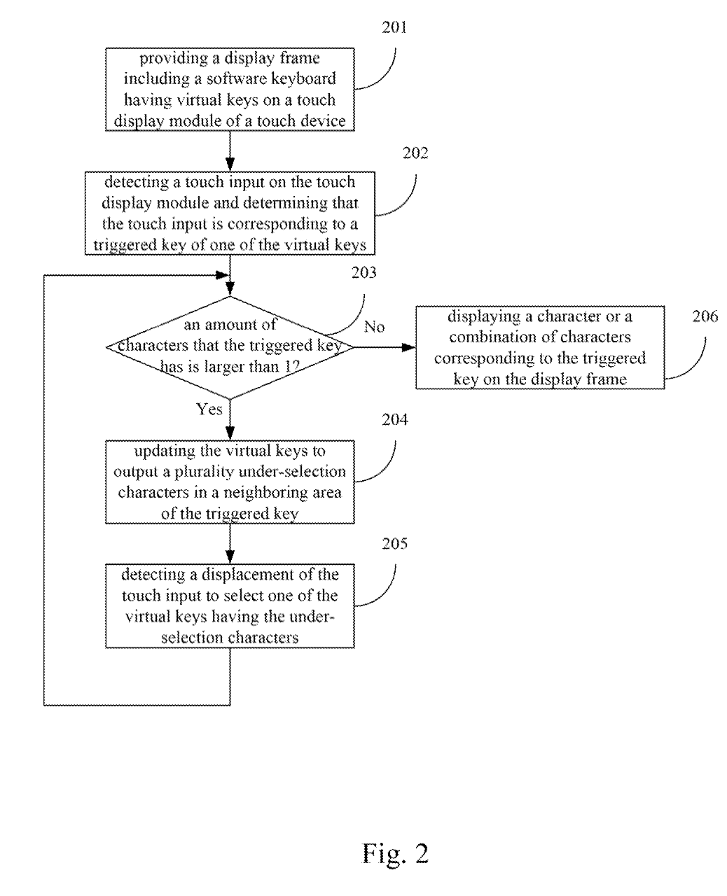

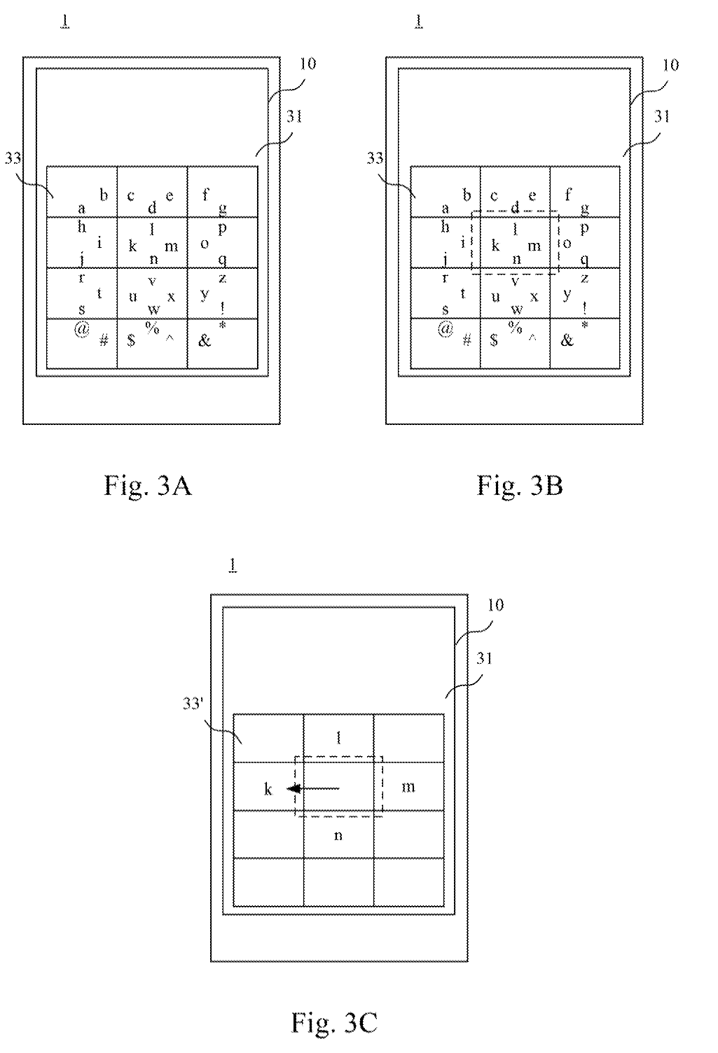

Please refer to FIG. 2 and FIGS. 3A-3C at the same time. FIG. 2 is a flow chart of the touch device operation method in an embodiment of the present disclosure, wherein the touch device operation method can be adapted to the touch device 1 depicted in FIG. 1. FIGS. 3A-3C are top views of the touch device 1 in different steps of the flow depicted in FIG. 2. The touch device operation method comprises the steps as follows. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, the touch display module 10 of the touch device 1 provides a display frame 31 to display a software keyboard having a plurality of virtual keys 33. As shown in FIG. 3A, there are twelve virtual keys 33 each having a plurality of characters in the present embodiment. For example, the virtual key 33 at the upper left corner includes the characters ‘a’ and The virtual key 33 at the lower right corner includes the signs ‘*’ and ‘&’. Due to the size of the touch display module 10, the display frame 31 is not able to display all the characters in different single keys. Hence, the virtual keys 33 each includes a plurality of characters are adapted.

The detecting module 12 detects a touch input 11 on the touch display module 10 in step 202. The determining module 14 further determines that the touch input 11 is corresponding to a triggered key of one of the virtual keys 33. The touch input 11 can be performed by the touch of a finger or a stylus. In the present embodiment, the touch input 11 is corresponding to the virtual key 33 that is circled by a dash-line frame as shown in FIG. 3B, where the corresponding virtual key 33 includes the characters of ‘k’, ‘l’, ‘m’ and ‘n’. Consequently, the virtual key 33 that includes the characters of ‘k’, ‘l’, ‘m’ and ‘n’ is the corresponding triggered key.

The determining module 14 further determines whether the amount of characters is larger than one. The determining result 13 that is generated by the determining module 14 according to step 202 and step 203 is transmitted to the processing module 16, such that when the determining result 13 shows that the amount of characters that the triggered key has is larger then one, the processing module 16 controls the touch display module 10 to update the virtual keys 33 in step 204. The updated virtual keys 33′ output a plurality under-selection characters in a neighboring area of the triggered key on the display frame 31. In the present embodiment, as shown in FIG. 3C, the under selection characters ‘k’, ‘l’, ‘m’ and ‘n’ that are included in the triggered key are outputted in the virtual keys 33 in the neighboring area of the triggered key.

The detecting module 12 further detects a displacement of the touch input 11 on the touch display module 10 in step 205 to select one of the virtual keys 33′ having the under-selection characters ‘k’, ‘l’, ‘m’ and ‘n’ respectively. In other words, after the user uses a finger or a stylus to generate the touch input 11 on the corresponding virtual key 33 to make the display frame 31 show the updated virtual keys 33′, the user can further move the finger or the stylus directly from the triggered key to one of the updated virtual keys 33′. The detecting module 12 is able to detect the displacement of the touch input. For example, as shown in FIG. 3C, the touch input 11 displaces from the triggered key to the position of the updated virtual key 33′ that includes the character ‘k’. Therefore, the touch device 1 can detect that the character ‘k’ is selected.

Before the displacement is sensed in step 205, the detecting module 12 keeps detecting the touch input 11 to determine whether the touch input 11 disappears. In other words, the detecting module 12 keeps detecting whether the finger or the stylus of the user leaves the touch display module 10. If the touch input 11 disappears, the display frame 21 stop showing the updated virtual keys 33′ that includes the under selection characters. In an embodiment, when the display frame 21 stops showing the updated virtual keys 33′, the virtual keys 33 previously shown on the display frame 21 are restored.

After one of the updated virtual keys 33′ is selected, the selected one can be treated as the triggered key such that step 203 is performed again to determine whether the amount of characters is larger than one. In the embodiment described above, the selected virtual key 33′ includes only one character ‘k’. Therefore, when the amount of characters is one, the character (‘k’ in the present example) in the triggered key is displayed on the display frame 21 in step 206.

Through the operation method described above, the virtual keys 33′ shown in the neighbor of the triggered key provide a dynamic virtual feedback mechanism. The under selection characters will not be blocked when the finger or the stylus is used to operate the touch display panel 10 of the touch device 1 such that the user can clearly specify the position of the under selection characters and further move the finger or the stylus to the correct character. The chance of a false input action is lowered.

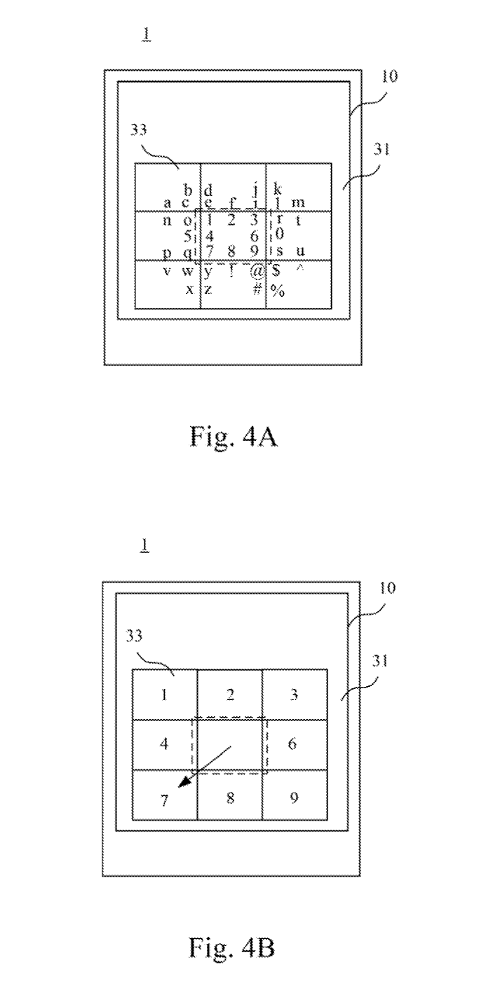

Please refer to FIG. 4A and FIG. 4B at the same time. FIG. 4A and FIG. 4B are top views of the touch device 1 in different steps of the flow depicted in FIG. 2 in another embodiment of the present disclosure. In FIG. 4A, the display frame 31 is provided on the touch display module 10 of the touch device 1. The display frame 31 includes a software keyboard having a plurality of virtual keys 33. In the present embodiment, one of the virtual keys 33 includes numbers 1 to 9. After the virtual key 33 that includes the numbers 1 to 9 is selected as the triggered key according to the steps 201-203 in the flow depicted in FIG. 2, the updated virtual keys 33′ outputs these numbers in the neighbor of the triggered key, as shown in FIG. 4B. Hence, an oblique displacement can be made to select the number 7 to be outputted on the display frame 31.

Accordingly, the displacement of the touch input can be used to select the updated virtual keys in whether a horizontal, a vertical or an oblique direction, as shown in the embodiments depicted in FIGS. 3A-3C and FIGS. 4A-4B.

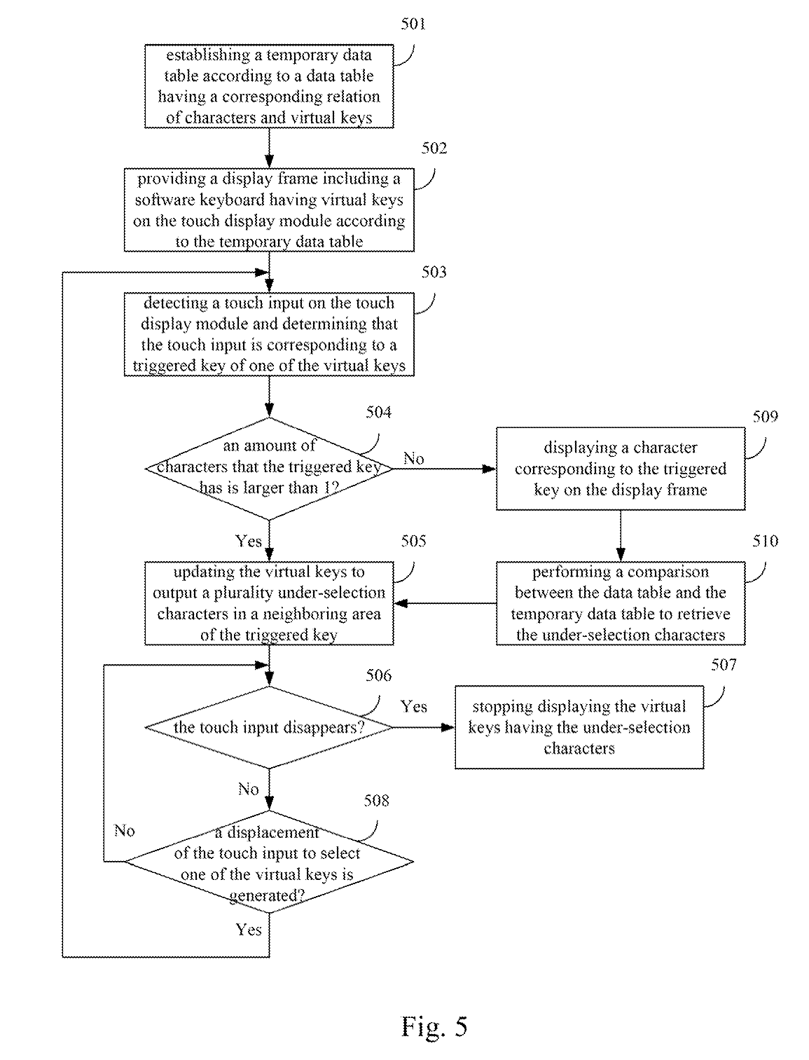

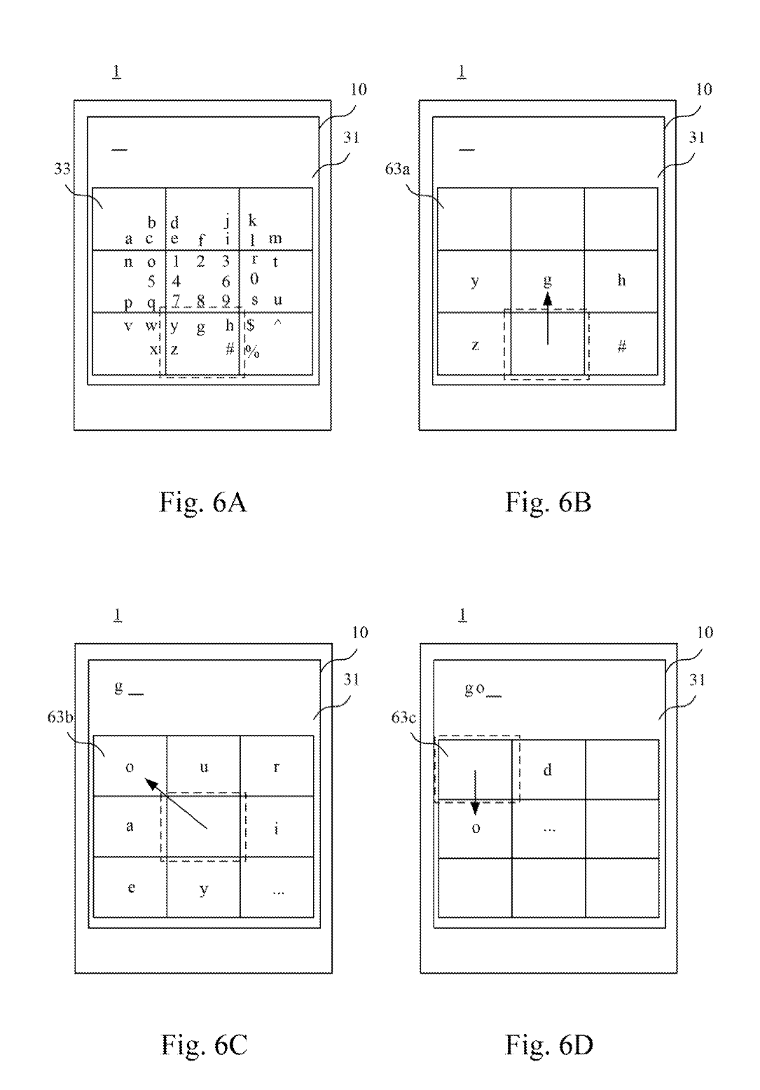

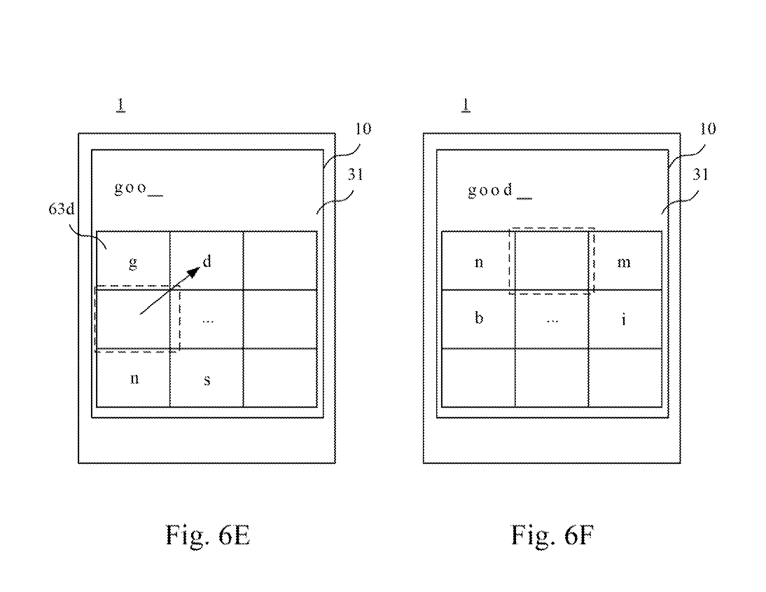

Please refer to FIG. 5 and FIGS. 6A-6F at the same time. FIG. 5 is a flow chart of the touch device operation method in another embodiment of the present disclosure, wherein the touch device operation method can be adapted to the touch device 1 depicted in FIG. 1. FIGS. 6A-6F are top views of the touch device 1 in different steps of the flow depicted in FIG. 5. The touch device operation method comprises the steps as follows. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

The touch device 1 substantially includes a storing module 18. The storing module 18 can be a memory or other kind of storage media. In step 501, the processing module 16 retrieves a data table (not shown) stored in the storing module 18 and establishes a temporary data table 15 according to the data table. The data table includes a corresponding relation of a plurality of characters and the virtual keys. In other words, the data table includes the information of the characters included in each virtual key, the inter-relation of the characters and the position that the virtual keys supposed to be shown on the display frame according to the inter-relation of the characters. The temporary data table 15 includes a temporary corresponding relation of the characters and the virtual keys and the established temporary data table 15 can be stored in the storing module 18 as well.

The processing module 16 provides the display frame 31 on the touch display module 10 according to the temporary data table 15 in step 502. According to the initial condition of the temporary corresponding relation of the characters and the virtual keys in the temporary data table 15, the processing module 16 makes the display frame 31 show a software keyboard that includes a plurality default virtual keys 33. As shown in FIG. 6A, there are nine virtual keys 33 in the present embodiment.

The detecting module 12 detects a touch input 11 on the touch display module 10 in step 503. The determining module 14 further determines that the touch input 11 is corresponding to a triggered key of one of the virtual keys 33. In the present embodiment, the determining module 14 looks up the temporary data table 15 according to the position of the touch input 11 on the display frame 31 to specify the which virtual key 33 is on the touched position. In the present embodiment, the touch input 11 is corresponding to the virtual key 33 that is circled by a dash-line frame as shown in FIG. 6A, where the corresponding virtual key 33 (triggered key) includes the characters of ‘g’, ‘h’, ‘y’ ‘z’ and ‘#’.

The determining module 14 further determines the amount of the characters that the triggered key has. In an embodiment, the step 504 can be performed along with the determination of the triggered key at the same time by looking up the temporary data table 15 according to the position of the touch input 11 on the display frame 31 to specify the amount of the characters that the triggered key has. In the present embodiment, the amount of characters is five, which is larger than one. The processing module 16 updates the temporary corresponding relation of the characters and the virtual keys of the temporary data table 15 according to the triggered key to make the virtual keys 33 output the under-selection characters, namely ‘g’, ‘h’, ‘y’ ‘z’ and ‘#’, on the updated virtual keys 63a on the display frame 31 according to the updated temporary data table 15. In the present embodiment, the processing module 16 looks up the temporary data table 15 to find the under selection characters included in the triggered key and the virtual keys related to the triggered key so that the processing module 16 can enable the related virtual keys that are in the neighbor of the triggered key and disable the unrelated virtual keys that are not in the neighbor of the triggered key. The processing module 16 further controls the touch display module 10 to write the under-selection characters to the related virtual keys in the neighboring area of the triggered key and write a null character to each of the unrelated virtual keys not in the neighboring area of the triggered key.

The detecting module 12 further determines whether the touch input 11 disappears is step 506. When the touch input 11 disappears, the virtual keys 63a including the under selection characters are stopped to be shown on the display frame 31 in step 507. In an embodiment, after step 507, the processing module 16 further restores the previous temporary data table 15 and the flow goes back to step 502. When the touch input 11 does not disappear, the detecting module 12 determines whether a displacement from the triggered key to the virtual keys 63a is generated in step 508. When the displacement is not generated yet, the step 506 is performed again. When the displacement is generated, step 503 is performed to determine the triggered key according to the displacement to perform the subsequent steps in the flow. In the present embodiment, the displacement of the touch input 11 selects the character ‘g’.

In an embodiment, the ‘g’ can be directly displayed when no under selection character is corresponding to the character ‘g’. However, in the present embodiment, when the determining module 14 determines that the amount of the characters that the triggered key has is not larger than one, step 510 is performed after the character ‘g’ is displayed in step 509.

In step 510, the processing module 16 makes a comparison between the data table and the temporary data table 15. In the present embodiment, the temporary data table 15 keeps a character combination record along the process of the flow. The character combination record keeps track of the combination of the characters that are already inputted by the user so that the processing module 16 can looks up the data table to check whether there are still related under selection characters available. The processing module 16 retrieves the under selection characters in the next stage to updated the temporary corresponding relation of the characters and the virtual keys in the temporary data table 15. The touch display module 10 further outputs the under selection characters in the virtual keys 63a of the display frame 31 according to the updated temporary data table 15. For example, the touch device 1 can check each possible combination of the characters according to an intelligent input algorithm. After the character ‘g’ is selected, the data table is looked up such that the entries of the impossible combinations of characters in the temporary data table 15, such as “gb” or “gz”, are written by a null character. The virtual keys in the display frame 31 are thus updated in step 505 according to the possible combinations of characters left in the temporary data table 15. The updated virtual keys 63b are shown in FIG. 6C. It's noticed that when the number of the possible combinations is beyond the number that can be shown on the display frame 31, a virtual key of the sign “ . . . ” can be shown to intimate the user that there are still more options. In the present embodiment, the character ‘o’ is further selected in FIG. 6C. The virtual keys 63c are then updated in FIG. 6D such that the character ‘o’ is again character ‘o’. The virtual keys 63d are then updated in FIG. 6E such that the character ‘d’ is selected. If “good” is the term that the user wants, the user can simply leave the finger or the stylus from the touch display module 10 to stop the flow. Hence, the term “good” is displayed on the touch display module 10 as shown in FIG. 6F.

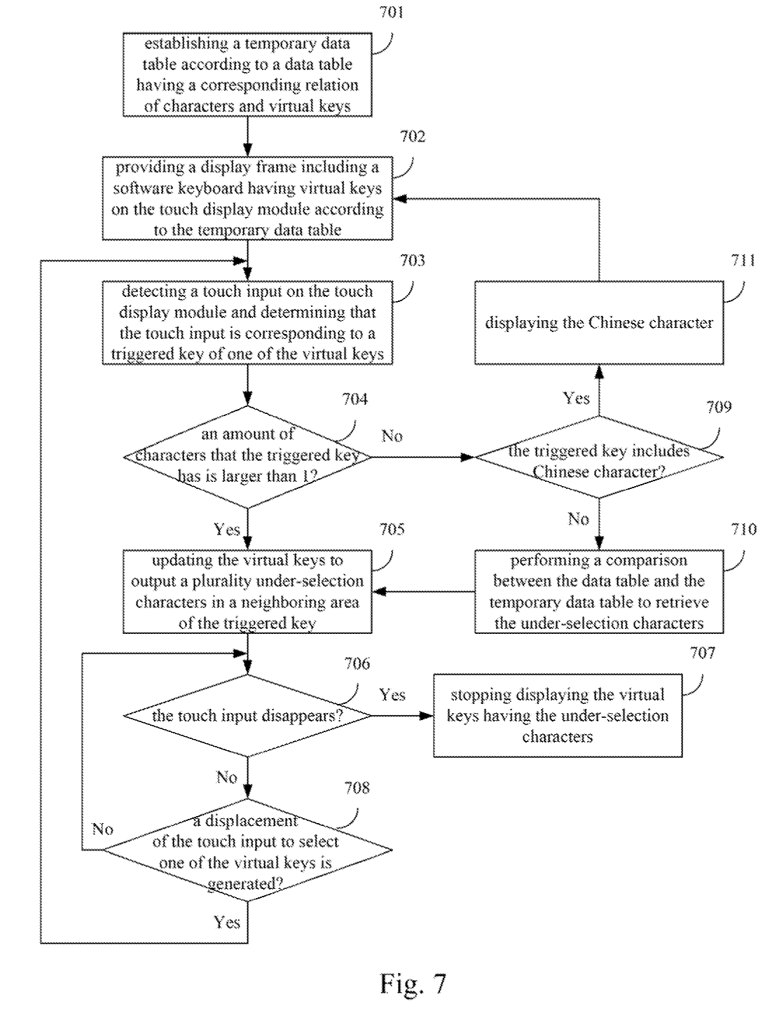

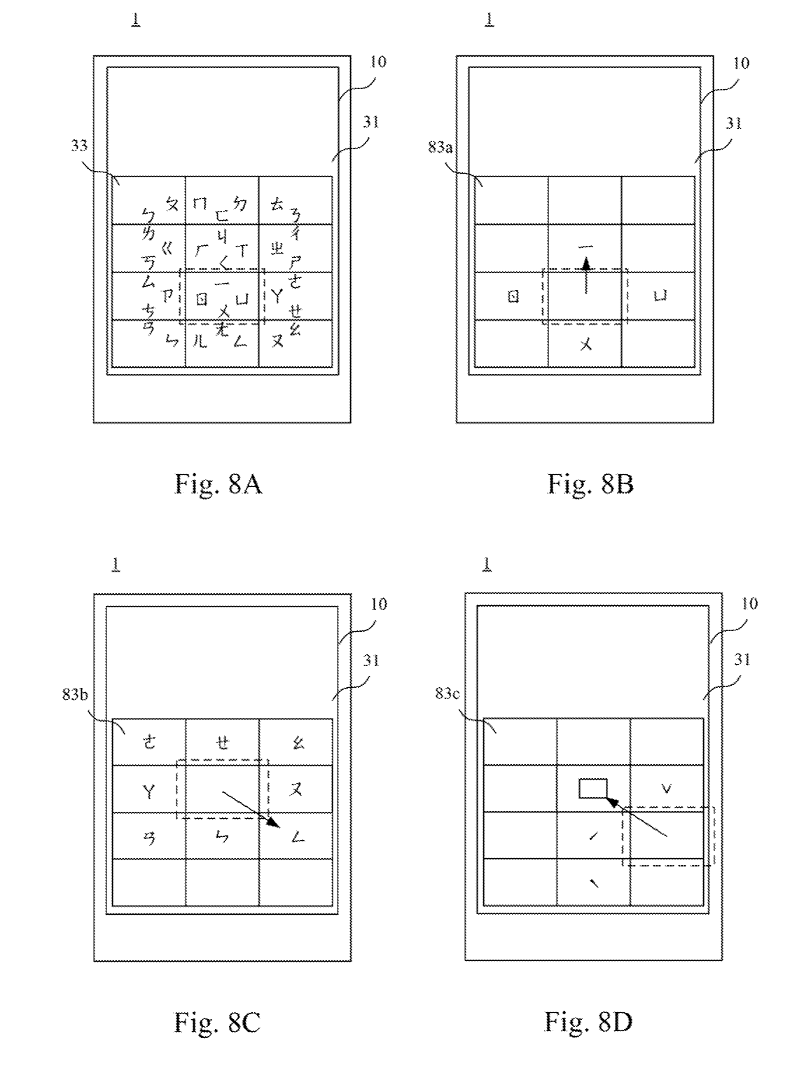

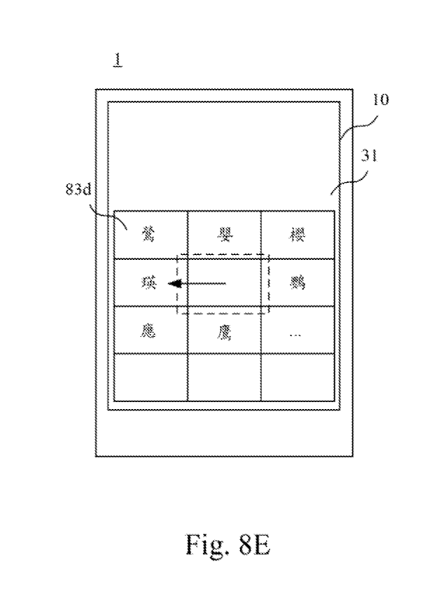

Please refer to FIG. 7 and FIGS. 8A-8E at the same time. FIG. 7 is a flow chart of the touch device operation method in yet another embodiment of the present disclosure, wherein the touch device operation method can be adapted to the touch device 1 depicted in FIG. 1. FIGS. 8A-8E are top views of the touch device 1 in different steps of the flow depicted in FIG. 7. The touch device operation method comprises the steps as follows. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

The flow can also be used to input Chinese characters. Most steps of the flow are similar to those depicted in FIG. 5. The phonetic notions in Chinese language are selected and the related phonetic notions suggested by the intelligent input algorithm are shown on the updated virtual keys. The only difference is that when the correct combination of the phonetic notions is found, the data table is looked up to find the corresponding Chinese characters such that the corresponding Chinese characters can be shown on the display frame 31. Each selected character is examined to determine whether it is a Chinese character in step 709 of the flow. When the selected character is a Chinese character (i.e. not a phonetic notion), the Chinese character is displayed in step 711 and the flow goes back to step 702 to show the default software keyboard. For example, please refer to FIGS. 8A-8E, which are top views of the touch device 1 in different steps of the flow. In FIG. 8A, the virtual key 33 includes four phonetic notions are selected by the touch input. One of the four phonetic notions outputted in the updated virtual keys 83a are then selected. The single phonetic notions is not a Chinese character, thus the processing module 16 updates the temporary data table 15 after looking up the data table according to the combination of the characters. The under selection characters in the next stage are shown in the virtual keys 83b depicted in FIG. 8C. After one of the phonetic notions is further selected, the four tones are shown as the under selection characters. After the first tone is selected, the virtual keys 83d depicted in FIG. 8E outputs a plurality of Chinese characters that have the corresponding pronunciation. One of the virtual keys showing “ . . . ” allows the user to look for more possible Chinese characters. In the present embodiment, a left direction displacement is made to select the Chinese character in one of the virtual keys 83d. Hence, the selected character is determined to be a Chinese character in step 709. The processing module 16 controls the touch display module 10 to display the selected Chinese character.

The touch device and the operation method of the same in the present disclosure provides an efficient visual feedback mechanism such that the user can easily select the under selection characters outputted in the neighbor of the triggered key.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A touch device operation method adapted in a touch device, wherein the touch device operation method comprises the steps of:
providing a display frame on a touch display module of the touch device, wherein the display frame displays a software keyboard having a plurality of virtual keys;
detecting a touch input on the touch display module;
determining that the touch input is corresponding to a triggered key of one of the virtual keys;
determining an amount of characters that the triggered key has such that when the amount of characters is not larger than one, a character corresponding to the triggered key is displayed on the display frame;
updating the virtual keys to output a plurality under-selection characters in a neighboring area of the triggered key when the amount of characters is larger than one; and
detecting a displacement of the touch input to select one of the virtual keys having the under-selection characters.

2. The touch device operation method of claim 1, wherein before the step of detecting the displacement of the touch input further comprising determining whether the touch input disappears such that the display frame stops to display the virtual keys having the under-selection characters when the touch input disappears.

3. The touch device operation method of claim 1, further comprising a step of treating one of the virtual keys that is selected by the displacement of the touch input as the triggered key to perform the step of determining the amount of characters that the triggered key has.

4. The touch device operation method of claim 1, wherein before the step of providing the display frame on the touch display module further comprising the steps of:
establishing a temporary data table according to a data table, wherein the data table comprises a corresponding relation of a plurality of characters and the virtual keys, and the temporary data table comprises a temporary corresponding relation of the characters and the virtual keys; and
providing the display frame according to the temporary data table.

5. The touch device operation method of claim 4, wherein the step of determining the amount of characters that the triggered key has further comprises looking up the temporary data table according to the position of the triggered key on the display frame.

6. The touch device operation method of claim 4, wherein after the step of determining that the amount of characters is larger than one, further comprises a step of:
updating the temporary corresponding relation of the characters and the virtual keys of the temporary data table according to the triggered key to make the virtual keys output the under-selection characters on the display frame according to the updated temporary data table.

7. The touch device operation method of claim 6, wherein the step of making the virtual keys output the under-selection characters further comprises:
writing the under-selection characters to the virtual keys in the neighboring area of the triggered key; and
writing a null character to each of the virtual keys not in the neighboring area of the triggered key.

8. The touch device operation method of claim 4, after the step of determining the amount of characters is not larger than one further comprising the steps of:
determining whether the character in the triggered key is a Chinese character such that when the character is a Chinese character, the Chinese character is outputted on the display frame; and
when the character is not a Chinese character, a comparison between the data table and a character combination record of the temporary data table is performed to retrieve the under-selection characters from the data table to update the temporary corresponding relation of the characters and the virtual keys to further make the virtual keys to output the under-selection characters according to the updated temporary data table.

9. The touch device operation method of claim 4, after the step of determining the amount of characters is not larger than one further comprising a step of:
performing a comparison between the data table and a character combination record of the temporary data table to retrieve the under-selection characters from the data table to update the temporary corresponding relation of the characters and the virtual keys to further make the virtual keys to output the under-selection characters according to the updated temporary data table.

10. A touch device having a dynamic visual feedback mechanism, wherein the touch device comprises:
a touch display module to provide a display frame to display a software keyboard having a plurality of virtual keys;
a detecting module to detect a touch input on the touch display module;
a determining module to determine that the touch input is corresponding to a triggered key of one of the virtual keys and the amount of characters that the triggered key has; and
a processing module to control the touch display module such that when the amount of characters is not larger than one, the character is displayed on the display frame and when the amount of characters is larger than one, the virtual keys are updated to output a plurality under-selection characters in a neighboring area of the triggered key;
wherein the detecting module further detects a displacement of the touch input to select one of the virtual keys having the under-selection characters.

11. The touch device of claim 10, wherein the detecting module further determines whether the touch input disappears such that characters when the touch input disappears, the processing module controls the touch display module to make the display frame stops to display the virtual keys having the under-selection.

12. The touch device of claim 10, wherein one of the virtual keys that is selected by the displacement of the touch input is treated as the triggered key such that the amount of characters that the triggered key has is determined by the determining module.

13. The touch device of claim 10, further comprising a storing module to store a data table, the processing module further retrieves the data table to establish a temporary data table in the storing module according to the data table to provide the display frame on the touch display module according to the temporary data table, wherein the data table comprises a corresponding relation of a plurality of characters and the virtual keys and the temporary data table comprises a temporary corresponding relation of the characters and the virtual keys.

14. The touch device of claim 13, wherein the determining module looks up the temporary data table according to the position of the triggered key on the display frame to determine the amount of characters that the triggered key has.

15. The touch device of claim 13, wherein the processing module updates the temporary corresponding relation of the characters and the virtual keys of the temporary data table according to the triggered key when the amount of characters is larger than one to make the virtual keys output the under-selection characters on the display frame according to the updated temporary data table.

16. The touch device of claim 15, wherein the processing module writes the under-selection characters to the virtual keys in the neighboring area of the triggered key and writes a null character to each of the virtual keys not in the neighboring area of the triggered key.

17. The touch device of claim 13, wherein the determining module further determines whether the character in the triggered key is a Chinese character when the amount of characters is not larger than one, such that when the character is a Chinese character, the Chinese character is outputted on the display frame and when the character is not a Chinese character, a comparison between the data table and a character combination record of the temporary data table is performed to retrieve the under-selection characters from the data table to update the temporary corresponding relation of the characters and the virtual keys to further make the virtual keys to output the under-selection characters according to the updated temporary data table.

18. The touch device of claim 13, wherein the determining module performs a comparison between the data table and a character combination record of the temporary data table when the amount of characters is not larger than one to retrieve the under-selection characters from the data table to update the temporary corresponding relation of the characters and the virtual keys to further make the virtual keys to output the under-selection characters according to the updated temporary data table.
